(19) United States
(12) Patent Application Publication
(10) Pub. No.: US 2014/0018226 A1
(43) Pub. Date: Jan. 16, 2014

(54) SHEET PROCESSING APPARATUS, AND IMAGE FORMING SYSTEM

(71) Applicant: FUJI XEROX CO., LTD., Tokyo (JP)

(72) Inventor: Katsunori HARADA, Kanagawa (JP)

(73) Assignee: FUJI XEROX CO., LTD., Tokyo (JP)

(21) Appl. No.: 13/766,114

(22) Filed: Feb. 13, 2013

(30) Foreign Application Priority Data
Jul. 12, 2012 (JP) 2012-156905

(51) Int. Cl. B31F 1/00

(52) U.S. Cl. CPC B31F 1/0009
USPC 493/416

(57) ABSTRACT

A sheet processing apparatus includes a sheet transport path along which a sheet is transported and plural folding members that perform folding processing on the sheet, wherein any folding member of the plural folding members includes a transport unit that includes first and second transport members coming into contact with each other and transports a sheet, which is sent to a contact portion between the first and second transport members, to the downstream side, a first sending member that is positioned on the upstream side of the transport unit and sends the sheet to the contact portion so that a portion of the transported sheet becomes a head, and a second sending member that is positioned on the upstream side of the transport unit and sends the sheet to the contact portion so that any of upstream and downstream end portions of the transported sheet becomes a head.

### CROSS-REFERENCE TO RELATED APPLICATIONS

This application is based on and claims priority under 35 USC 119 from Japanese Patent Application No. 2012-156905 filed Jul. 12, 2012.

### BACKGROUND

### Technical Field

The present invention relates to a sheet processing apparatus, and an image forming system.

### SUMMARY

According to an aspect of the invention, there is provided a sheet processing apparatus including: a sheet transport path along which a sheet is transported; and plural folding members that are disposed at positions different from each other on the sheet transport path in a sheet transport direction and perform folding processing on the sheet transported along the sheet transport path, wherein any folding member of the plural folding members includes a transport unit that includes a first transport member and a second transport member disposed so as to come into contact with the first transport member and transports a sheet, which is sent to a contact portion where the first and second transport members come into contact with each other, to the downstream side, a first sending member that is positioned on the upstream side of the transport unit in the sheet transport direction, and sends the sheet to the contact portion so that a portion of the transported sheet, which is positioned closer to an upstream end portion than an downstream end portion of the transported sheet positioned on the downstream side in the sheet transport direction and is positioned closer to the downstream end portion than the upstream end portion, becomes a head, and a second sending member that is positioned on the upstream side of the transport unit in the sheet transport direction, and sends the sheet to the contact portion so that any of the upstream end portion and the downstream end portion of the transported sheet becomes a head.

### BRIEF DESCRIPTION OF THE DRAWINGS

Exemplary embodiments of the present invention will be described in detail based on the following figures, wherein:

FIG. 1 is a view showing the whole structure of an image forming system according to an exemplary embodiment;

FIG. 2 is a view showing the detail of a folding function section provided in a folding unit;

FIG. 3 is a view showing the mechanism of a sheet guide section from the front side of an apparatus;

FIG. 4 is a perspective view illustrating a sheet guide provided in the sheet guide section;

FIGS. 5A, 5B, and 5C are views illustrating the operation of the folding function section;

FIGS. 6A and 6B are views illustrating the operation of the sheet guide section;

FIG. 7 is a view showing an example of the state of a sheet that is transported;

FIGS. 8A, 8B, and 8C are views illustrating an operation when outside triple folding (Z-folding) is performed on a sheet;

FIG. 9 is a view showing an example of the sheet on which Z-folding has been performed;

FIGS. 10A, 10B, and 100 are views illustrating the operation of the folding function section when double folding is performed;

FIGS. 11A and 11B are views illustrating the operation of the folding function section when double folding is performed;

FIGS. 12A, 12B, and 12C are views illustrating the operation of the folding function section when the switchback of a sheet is performed;

FIGS. 13A and 13B are views illustrating the operation of the folding function section when the switchback of a sheet is performed; and

FIG. 14 is a view showing another example of the structure of the folding function section.

### DETAILED DESCRIPTION

An exemplary embodiment of the invention will be described below with reference to the accompanying drawings.

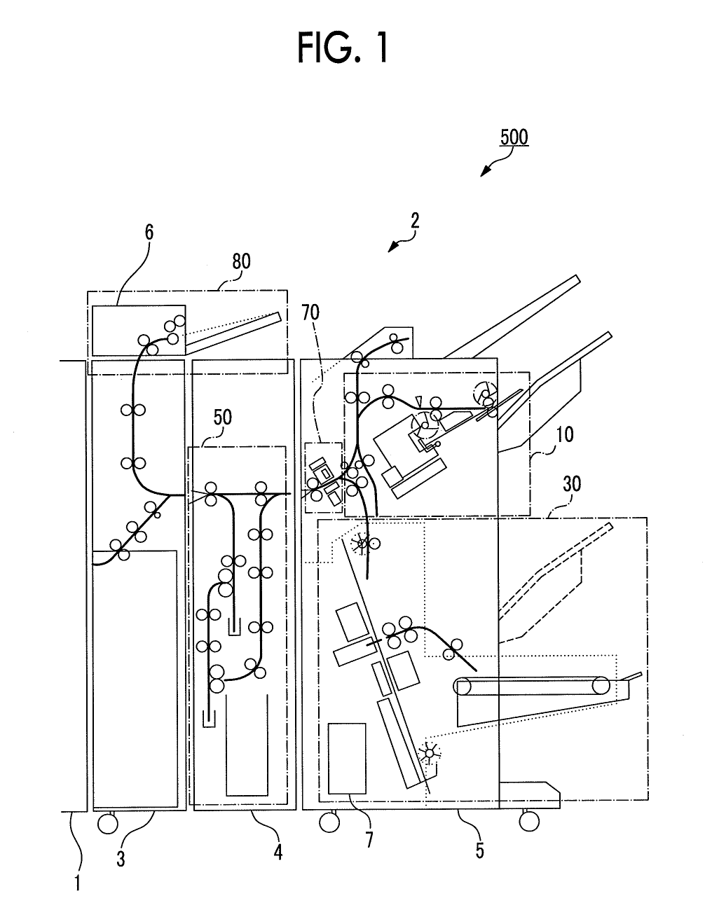

FIG. 1 is a view showing the whole structure of an image forming system 500 according to this exemplary embodiment.

The image forming system 500 according to this exemplary embodiment includes an image forming apparatus 1 that forms a color image on a sheet by an electrophotographic method. Further, the image forming system 500 includes a sheet processing apparatus 2 that performs predetermined processing on a sheet sent from the image forming apparatus 1.

Here, the image forming apparatus 1 as an example of an image forming section may include, for example, photoreceptor drums, chargers that charge the photoreceptor drums, laser exposure units that form electrostatic latent images by irradiating the photoreceptor drums with laser beams, developing devices that develop the electrostatic latent images formed on the photoreceptor drums by using toner, and transfer devices that transfer toner images formed on the photoreceptor drums to a sheet. Meanwhile, a case where an image is formed by an electrophotographic method is exemplified in this exemplary embodiment, but an image may be formed by an ink-jet method or the like.

Meanwhile, the sheet processing apparatus 2 includes a transport unit 3 that is connected to the image forming apparatus 1, and a folding unit 4 that includes plural folding processing parts (folding members) for performing folding processing on a sheet and performs folding processing on a sheet received by the transport unit 3. Further, the sheet processing apparatus 2 includes a finisher 5 that performs predetermined final processing on the sheet having passed through the folding unit 4, and an interposer 6 that feeds a lamination such as a cover of a book. Furthermore, the sheet processing apparatus 2 includes a controller 7 that controls the respective mechanisms of the sheet processing apparatus 2. Meanwhile, the controller 7 has been provided in a housing of the finisher 5 in FIG. 1, but may be provided in a housing of the other unit. Moreover, the image forming apparatus 1 may be adapted to have all control functions.

When the sheet processing apparatus 2 is divided in terms of function, the sheet processing apparatus 2 includes a staple function section 10 that is provided in the finisher 5, forms a sheet bundle, and performs staple binding; a saddle stitch bookbinding function section 30 that is provided in finisher 5 and saddle-stitches and binds the sheet bundle; and a folding function section 50 that is provided in the folding unit 4 and performs inside triple folding (C-folding) or outside triple folding (Z-folding) on a sheet. Further, the sheet processing apparatus 2 includes a punch function section 70 that is provided in the finisher 5 and performs two-hole or four-hole punching on a sheet, and an lamination function section 80 that is formed of an interposer 6 or the like and feeds a lamination, such as a cardboard or a window-opened sheet, used as a cover of a sheet bundle.

The folding function section 50 will be described in detail.

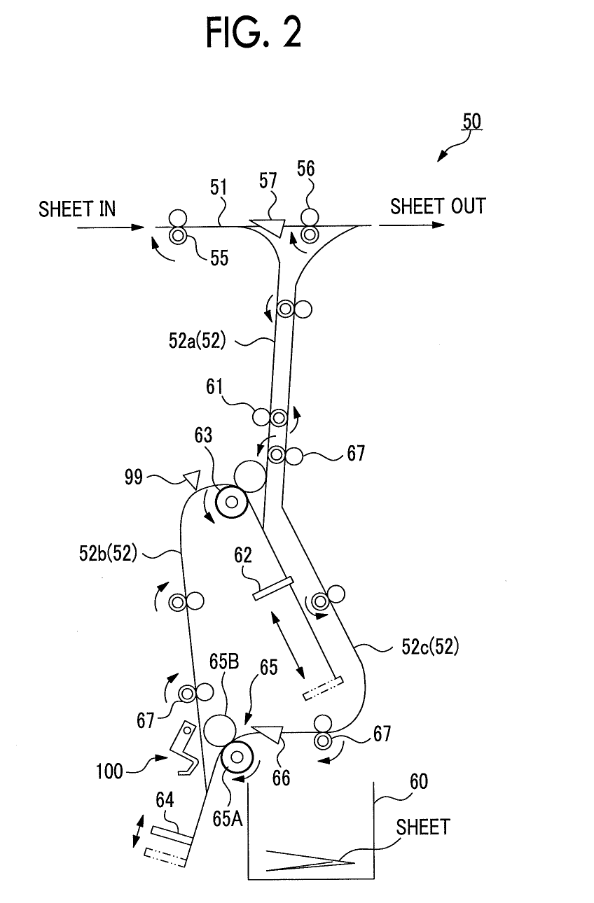

FIG. 2 is a view showing the detail of the folding function section 50 provided in the folding unit 4.

The folding function section 50 includes a linear transport path 51 that linearly connects a sheet inlet with a sheet outlet opened at the upper portion of the housing and a bypass transport path 52 that is branched from the linear transport path 51 once and then joins the linear transport path 51 again. A folding mechanism, which performs inside triple folding (C-folding) or outside triple folding (Z-folding) on a sheet, is provided on the middle of the bypass transport path 52 in this exemplary embodiment. Further, in this exemplary embodiment, a take-in roll 55 is provided near the inlet of the linear transport path 51 and a transport roll 56 is provided on the middle of the linear transport path 51. Furthermore, a switching gate 57 is provided at a portion where the bypass transport path 52 is branched from the linear transport path 51.

The bypass transport path 52 includes an inlet bypass transport path 52a that extends downward from the portion where the bypass transport path 52 is branched from the linear transport path 51, an intermediate bypass transport path 52b that is branched from the middle of the inlet bypass transport path 52a in a substantially C shape, and a return bypass transport path 52c that is branched from the middle of the intermediate bypass transport path 52b. In this exemplary embodiment, folding processing is performed on a sheet two times while the sheet is transported along the bypass transport path 52.

A skew correction roll 61, which can release a nip, is provided on the middle of the inlet bypass transport path 52a, and a first end guide 62, which can move up and down, is provided at the terminal end of the inlet bypass transport path 52a. Further, a first folding roll 63, which functions as a part of the folding members, is provided on the intermediate bypass transport path 52b near a connecting portion where the intermediate bypass transport path 52b and the inlet bypass transport path 52a are connected to each other. Furthermore, a second end guide 64, which can move up and down, is provided at the terminal end of the intermediate bypass transport path 52b. In this exemplary embodiment, a position where folding processing is performed on a sheet is changed according to the position of the first end guide 62 and the position of the second end guide 64.

Second folding rolls 65, which function as a part of the folding members, are provided on the upstream side of the return bypass transport path 52c in a sheet transport direction (near a connecting portion where the intermediate bypass transport path 52b and the return bypass transport path 52c are connected to each other). Here, the second folding rolls 65, which also function as a transport unit, are formed of a first transport roll 65A and a second transport roll 65B that is disposed so as to come into contact with the first transport roll 65A.

Here, the first transport roll 65A as an example of a first transport member is rotated in a clockwise direction in FIG. 2 by a driving force of a driving source (not shown). Further, the second transport roll 65B as an example of a second transport member is disposed so as to come into contact with the first transport roll 65A and is driven by the first transport roll 65A so as to be rotated in a counterclockwise direction in FIG. 2. Here, in this exemplary embodiment, a sheet is sent to the contact portion (nip portion) where the first and second transport rolls 65A and 65B come into contact with each other from the upstream side, folding processing is performed on the sheet, and the sheet on which the folding processing has been performed is further transported to the downstream side by the first and second transport rolls 65A and 65B.

Furthermore, a switching gate 66, which switches whether or not a sheet is allowed to pass through the return bypass transport path 52c, is provided right behind the second folding rolls 65 (on the downstream side). Moreover, a sheet accommodating device 60 in which envelope-folded sheets subjected to inside triple folding (C-folding) or the like (sheets that are subjected to folding processing in the shape to be put in envelopes) are accommodated is provided below the switching gate 66.

Further, plural transport rolls 67 are provided on the bypass transport path 52. Furthermore, in this exemplary embodiment, a sheet detection sensor 99 is provided near the first folding roll 63 on the upstream side of the intermediate bypass transport path 52b. Furthermore, a sheet guide section 100 is provided near the second folding rolls 65 on the middle of the intermediate bypass transport path 52b.

The sheet guide section 100 will be described.

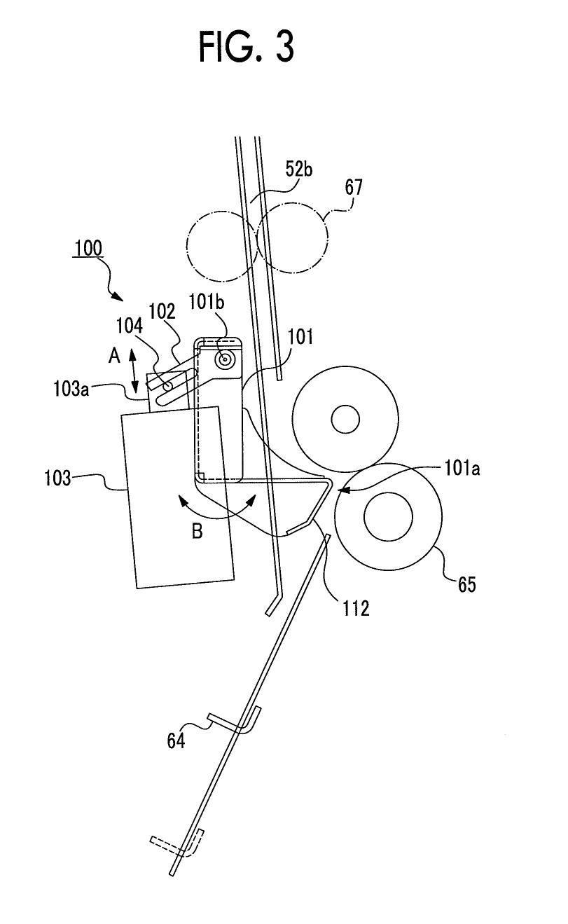

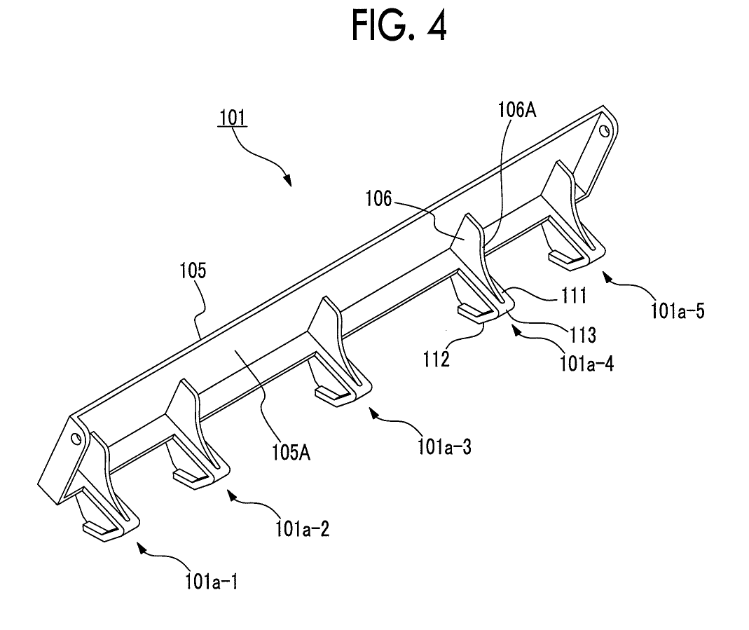

FIG. 3 is a view showing the mechanism of the sheet guide section 100 from the front side (outside) of the apparatus. FIG. 4 is a perspective view illustrating a sheet guide 101 provided in the sheet guide section 100.

As shown in FIGS. 3 and 4, the sheet guide section 100 includes a sheet guide 101 that includes plural (five in FIG. 4) end portions 101a (101a-1 to 101a-5) and is rotated about a rotational center 101b, a solenoid 103 that is a driving source for rotating the sheet guide 101, and a lever 102 that transmits a driving force of the solenoid 103 to the sheet guide 101.

Further, a shaft 103a of the solenoid 103 is provided with a pin 104 that connects the shaft 103a to the lever 102. Furthermore, a spring (not shown), which makes the shaft 103a protrude from the solenoid 103 when the shaft 103a is not pulled to the solenoid 103, is wound around the shaft 103a. Moreover, a shaft (not shown) as a rotating shaft is welded to both ends of the sheet guide 101 (both ends of the sheet guide 101 in a longitudinal direction) at the rotational center 101b. Meanwhile, this shaft is supported by an apparatus body with bearings (not shown) interposed therebetween.

In this exemplary embodiment, the shaft 103a is slidably moved in a direction A of FIG. 3 by the solenoid 103 as shown in FIG. 3. Further, when the shaft 103a is slidably moved, the lever 102 is rotated about the rotational center 101b. Furthermore, the sheet guide 101 is rotated about the rotational center 101b in the direction of an arrow B of FIG. 3 due to the rotation of the lever 102. Accordingly, the end portions 101a of the sheet guide 101 protrude to the intermediate bypass transport path 52b (also see FIG. 2), and the end portions 101a recede from the intermediate bypass transport path 52b. Furthermore, when the sheet guide 101 is rotated in the direction of the arrow B, the end portions 101a protrude toward the second folding rolls 65 and the end portions 101a recede so as to be separated from the second folding rolls 65.

As shown in FIG. 4, the plural end portions 101a (101a-1 to 101a-5) of the sheet guide 101 are disposed at predetermined intervals in the direction orthogonal to the sheet transport direction. The interval between these end portions 101a (101a-1 to 101a-5) corresponds to the size of a sheet to be transported or a method of transporting a sheet. Moreover, the sheet guide 101 of this exemplary embodiment includes a base 105 that is formed in the shape of a plate so as to extend in the direction orthogonal to the sheet transport direction as shown in FIG. 4. Further, in this exemplary embodiment, the end portions 101a (101a-1 to 101a-5) are formed so as to protrude from the lower end portion of the base 105 in FIG. 4.

Here, each of the end portions 101a includes an upstream side surface 111 that is positioned on the upstream side in the sheet transport direction when the end portions 101a protrude onto the intermediate bypass transport path 52b, and a downstream side surface 112 that is positioned on the downstream side of the upstream side surface 111 in the sheet transport direction when the end portions 101a protrude onto the intermediate bypass transport path 52b. Here, the downstream side surface 112 is inclined so as to be gradually distant from the upstream side surface 111 toward the side where the base 105 is provided from the side where an apex 113 of the end portion 101a is positioned.

Moreover, in this exemplary embodiment, a connecting portion 106, which is formed in the shape of a plate and connects the side surface 105A to each upstream side surface 111, is formed between one side surface 105A of the base 105 (the side surface of the base 105 where the end portions 101a are formed) and each upstream side surface 111. Here, an edge portion 106A, which is positioned on the side opposite to the side connected to the upstream side surface 111, of the connecting portion 106 is formed so as to gradually approach the upstream side surface 111 toward the side where the apex 113 is positioned from the side where the base 105 is provided.

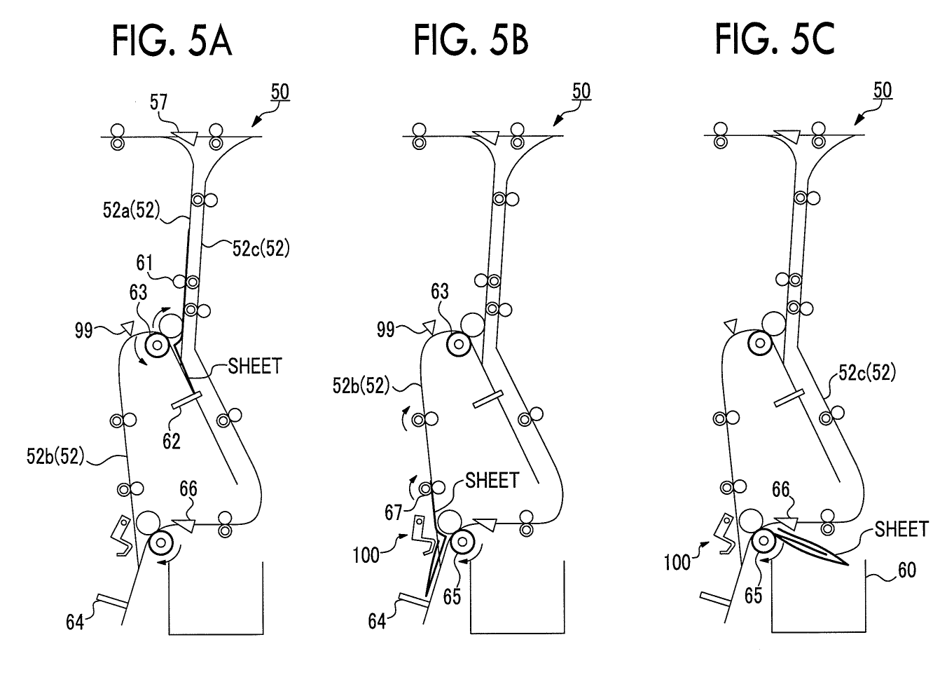

Next, the operation of the folding function section 50 will be described with reference to FIGS. 5A, 5B, and 5C (views illustrating the operation of the folding function section 50).

Meanwhile, here, there will be described an example of an operation when an image is formed on a small-sized sheet (for example, A4SEF) to be put in an envelope, is subjected to envelope folding processing corresponding to inside triple folding (C-folding), and is then discharged to the sheet accommodating device 60.

First, in the image forming apparatus 1 (see FIG. 1), fixing processing is performed after an image is formed on a sheet. After that, the sheet is delivered to the sheet processing apparatus 2. More specifically, the sheet is delivered to the folding function section 50 (folding unit 4) via the transport unit 3. Meanwhile, when folding processing is designated in the folding function section 50, the switching gate 57 is driven as shown in FIG. 5A so that the sheet is guided to the bypass transport path 52 and each of the end guides (the first and second end guides 62 and 64) is moved to a predetermined position. Further, when inside triple folding (C-folding) is performed, the switching gate 66 is switched to prevent the sheet from being moved to the return bypass transport path 52c as shown in FIG. 5A.

When the sheet is transported to the folding function section 50, this sheet is transported to the bypass transport path 52 as shown in FIG. 5A and the front end of the sheet bumps against the first end guide 62. Furthermore, first folding processing is performed by the first folding roll 63 functioning as a part of the folding members. Meanwhile, there is a concern that damage such as folding occurs at the front end portion of the sheet when the front end of the sheet bumps against the first end guide 62. For this reason, in this exemplary embodiment, the sheet bumps against the first end guide 62 after the transport speed of the sheet is reduced to speed (for example, 250 ms) lower than the transport speed of the sheet (for example, 800 ms) at the transport unit 3 or the image forming apparatus 1 positioned on the upstream side.

Further, in this exemplary embodiment, the correction of skew is performed by the skew correction roll 61. Here, a sheet skews (a sheet is fed while being inclined) on the transport path of the image forming apparatus 1 or on the transport path of a post-processing device (for example, the transport unit 3, the interposer 6, or the like) that is provided on the upstream side. Accordingly, the sheet, which has skewed, is sent to the folding function section 50. Furthermore, if the sheet, which has skewed, is sent to the first folding roll 63, the accuracy of a folding position is lowered. For this reason, the correction of skew is performed by the skew correction roll 61 as described above in this exemplary embodiment.

In the correction of skew, the sheet is transported by the skew correction roll 61 and the front end of the sheet bumps against the first end guide 62. Further, after the sheet is sent by a distance of several mm (for example, about 5 mm) and forms a loop, the nip of the skew correction roll 61 is released (two roll members pressed against each other are separated from each other). In such a case, the front end of the sheet becomes horizontal along the first end guide 62 and the rear end of the sheet also becomes horizontal so as to follow the front end of the sheet. Accordingly, the skew of the sheet is corrected.

After that, the sheet of which the skew has been completely corrected is nipped again by the skew correction roll 61, and is transported at a speed that is equal to or lower than the speed of the first folding roll 63. Accordingly, a folded portion of the sheet is buckled and a loop is formed in a space in front of the first folding roll 63 as shown in FIG. 5A. Therefore, the sheet is sent to the first folding roll 63 (the loop portion of the sheet is caught in the first folding roll 63) and the first folding processing is performed. In detail, when the sheet is sent by the skew correction roll 61, the sheet is buckled so as to be convex toward the first folding roll 63. Then, a buckled portion of the sheet enters a nip portion formed by the first folding roll 63. Accordingly, the first folding processing is performed on the sheet.

After that, the sheet is transported along the intermediate bypass transport path 52b. Meanwhile, when the sheet is transported along the intermediate bypass transport path 52b, the folded portion (front end) of the sheet to be transported is recognized by the sheet detection sensor 99. After that, the folded portion of the sheet, which is transported along the intermediate bypass transport path 52b, bumps against the second end guide 64. Subsequently, the sheet is further sent by the transport roll 67 in this exemplary embodiment.

Accordingly, as shown in FIG. 5B, a middle portion of the sheet is buckled and a loop is formed in a space in front of the second folding rolls 65. In detail, a portion of the sheet, which is positioned between a downstream end portion of the sheet positioned on the downstream side in the sheet transport direction and an upstream end portion of the sheet positioned on the upstream side in the sheet transport direction, is buckled, so that a loop is formed on the sheet. In more detail, a portion of the sheet, which is positioned closer to the upstream end portion than the downstream end portion and is positioned closer to the downstream end portion than the upstream end portion, is buckled, so that a loop is formed on the sheet.

Further, in this exemplary embodiment, a buckled portion (a loop portion) is sent to the second folding rolls 65 functioning as a part of the folding members and second folding processing is performed. In detail, in this exemplary embodiment, a loop is formed on the sheet by the transport roll 67 functioning as a first sending member and the second end guide 64. Then, the sheet is sent to (the nip portion of) the second folding rolls 65 so that this loop portion becomes the head. Accordingly, the second folding processing is performed on the sheet.

Here, in this exemplary embodiment, the solenoid 103 of the sheet guide section 100 is operated (turned on) when a predetermined time (for example, 200 ms) has passed after the folded portion (front end) of the sheet to be transported is recognized by the sheet detection sensor 99. Accordingly, the sheet guide, section 100 is operated.

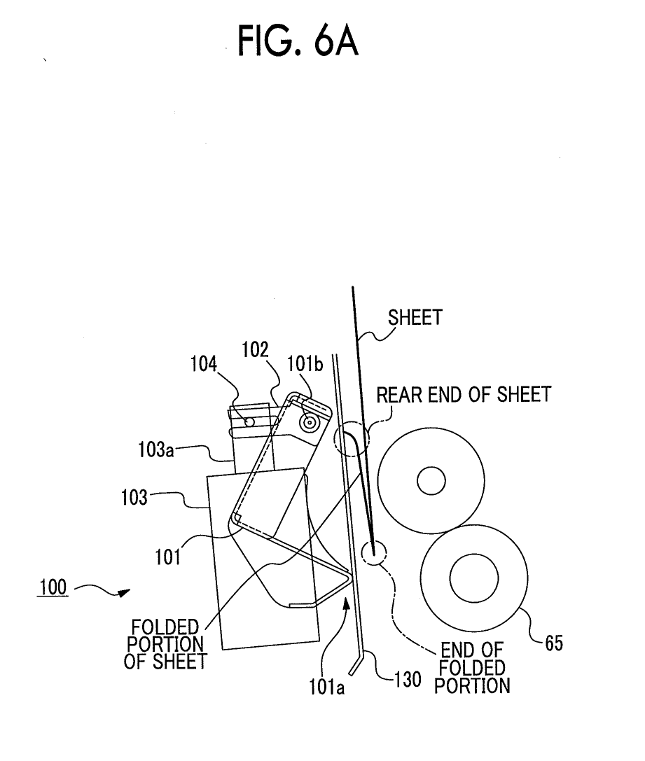

FIGS. 6A and 6B are views illustrating the operation of the sheet guide section 100, FIG. 6A shows a first state where the end portions 101a of the sheet guide 101 recede from the intermediate bypass transport path 52b, and FIG. 6B shows a second state where the end portions 101a protrude onto the intermediate bypass transport path 52b.

While the sheet on which the first folding processing has been performed is transported along the intermediate bypass transport path 52b so that the folded portion becomes the head (before the sheet bumps against the second end guide 64), the end portions 101a of the sheet guide section 100 wait in a state where the end portions 101a of the sheet guide section 100 are pulled to the outside of a transport guide 130 forming the intermediate bypass transport path 52b as shown in FIG. 6A (first state).

More specifically, the solenoid 103 is turned off and the shaft 103a of the solenoid 103 protrudes. In this case, the lever 102 is rotated about the rotational center 101b to the right (in the clockwise direction), so that the sheet guide section 100 is also rotated about the rotational center 101b to the right (in the clockwise direction). Further, the end portions 101a recede from the intermediate bypass transport path 52b in this state.

Furthermore, the state of the transported sheet is exemplified in FIG. 6A. A situation where the rear end of the folded portion of the sheet is curled (curled state) is shown here. There is a case where the rear end of a sheet, which is heated and pressed by a fixing device of the image forming apparatus 1, is curled according to the aqueous state of the sheet, the state of the sheet, or the like, that is, a so-called down curl occurs. When the first folding processing is performed in a state where such a down curl occurs at the rear end of the sheet (the rear end of the folded portion of the sheet), the curl is opened to the outside as shown in FIG. 6A.

Moreover, in this exemplary embodiment, processing for pushing the rear end of the folded portion of the sheet into the second folding rolls 65 is performed when the second folding processing is performed. That is, the controller 7 shown in FIG. 1 or a controller (not shown) provided in the image forming apparatus 1 instructs the solenoid 103 to perform a pulling operation and performs processing for pushing the rear end of the folded portion of the sheet into the second folding rolls 65 at a timing when, for example, 200 ms has passed after the folded portion (front end) of the sheet to be transported is recognized by the sheet detection sensor 99.

In detail, the controller 7 or a controller provided in the image forming apparatus 1 turns on the solenoid 103 at a timing when, for example, 200 ms has passed after the folded portion (front end) of the sheet to be transported is recognized by the sheet detection sensor 99. Accordingly, the shaft 103a is pulled in a direction S shown in FIG. 6B, and the lever 102 and the sheet guide 101 are rotated about the rotational center 101b in a direction T of FIG. 6B (the counterclockwise direction).

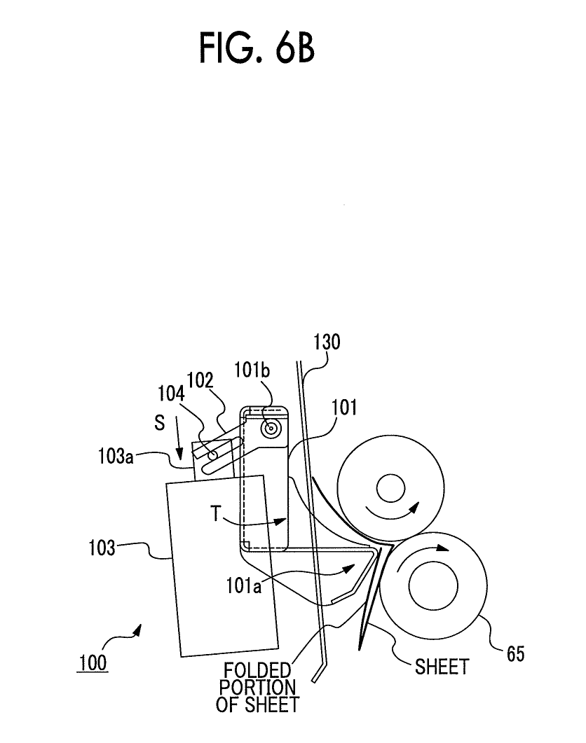

Further, the end portions 101a protrude from the transport guide 130 forming the intermediate bypass transport path 52b in this case, and the apexes 113 (see FIG. 4) of the end portions 101a push the rear end of the sheet (a portion of the sheet where curl occurs) into the second folding rolls 65. Accordingly, the bending of a sheet, which may occur at the rear end of a sheet, (see FIG. 7 (a view showing an example of the state of a sheet that is transported) is suppressed.

In detail, in this exemplary embodiment, the solenoid 103 is turned on at a predetermined timing after the folded portion (front end) of the sheet to be transported is recognized by the sheet detection sensor 99. Accordingly, the sheet guide 101 as an example of an advance member advances toward the second folding rolls 65 from the side opposite to the side where the second folding rolls 65 nipping the sheet are provided. Therefore, the end portions 101a push the rear end of the sheet (a portion of the sheet where curl occurs) into the second folding rolls 65, so that C-folding is suppressed while the end of the sheet is bent.

Returning to FIG. 5, description further continues to be made.

After the second folding processing is completed, the sheet is guided by the switching gate 66 so that the sheet is discharged to the sheet accommodating device 60 dedicated to an envelope-folded sheet as shown in FIG. 5C. In detail, in this exemplary embodiment, the sheet subjected to inside triple folding (C-folding) processing free falls and is accommodated in the sheet accommodating device 60 immediately after passing through the second folding rolls 65.

Next, there will be described an operation when outside triple folding (Z-folding) is performed on a sheet. Meanwhile, folding processing, which is performed when a sheet is put in an envelope, will also be described here.

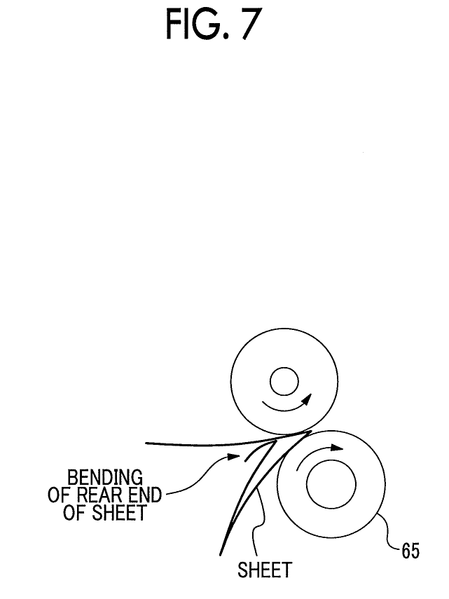

FIGS. 8A, 8B, and 8C are views illustrating an operation when outside triple folding (Z-folding) is performed on a sheet.

When Z-folding is instructed from a user at, for example, an operation input section (not shown) of the image forming apparatus 1, the switching gate 57 is driven in the folding function section 50 so as to guide a sheet to the inlet bypass transport path 52a as shown in FIG. 8A and as described above.

Further, when Z-folding is instructed from the user, the first and second end guides 62 and 64 are moved to predetermined positions. In particular, the position of the first end guide 62 is adjusted so as to correspond to ⅓ of the size of the sheet to be folded. Furthermore, when the Z-folding is instructed from the user, the switching gate 66 is driven so that the movement of a sheet to the return bypass transport path 52c is prevented.

The sheet from the image forming apparatus 1 is sent to the inlet bypass transport path 52a after this state. Further, the sheet is transported via the skew correction roll 61 as shown in FIG. 8A, and is further transported until the front end of the sheet bumps against the first end guide 62. Accordingly, the skew of the sheet is corrected as described above in this case.

Furthermore, the sheet of which the skew has been corrected is transported at a speed, which is equal to or lower than the speed of the first folding roll 63, while the front end of the sheet bumps against the first end guide 62. Accordingly, the folded portion (see reference numeral p1) of the sheet is buckled and a loop is formed in the space in front of the first folding roll 63 as described above. Moreover, this folded portion is sent to the first folding roll 63, so that the first folding processing is performed.

After that, the sheet is transported along the intermediate bypass transport path 52b. Meanwhile, at this time, the folded portion (front end) of the sheet is recognized by the sheet detection sensor 99. After that, the folded portion (front end) of the sheet, which is transported along the intermediate bypass transport path 52b, bumps against the second end guide 64. Subsequently, when the solenoid 103 is turned on, the sheet guide section 100 pushes the middle portion (a position denoted by reference numeral p2) of the sheet into the second folding rolls 65 in the space in front of the second folding rolls 65 as shown in FIG. 8B. Accordingly, the second folding processing is performed on a portion that is different from a portion on which the first folding processing has been performed.

Here, a timing when the sheet guide section 100 pushes the sheet into the second folding rolls 65 is set on the basis of the recognition of the folded portion (front end) of the sheet that is performed by the sheet detection sensor 99 as described above. Meanwhile, when outside triple folding (Z-folding) is performed, the bending of the sheet, which is shown in FIG. 7, does not occur at the end portion of the sheet. For this reason, when outside triple folding (Z-folding) is performed, the pushing of the sheet into the second folding rolls 65, which is performed by the sheet guide section 100, may be omitted.

After the second folding processing is completed, the sheet is sent to the sheet accommodating device 60 by the switching gate 66 as shown in FIG. 8C like in the case where C-folding is performed. That is, the movement of the sheet, which has been completely subjected to the folding processing performed by the second folding rolls 65, to the return bypass transport path 52c is prevented by the switching gate 66, and the sheet free falls. Further, the sheet is accommodated in the sheet accommodating device 60 that is positioned on the lower side.

Meanwhile, in addition to the above-mentioned inside triple folding (C-folding) or outside triple folding (Z-folding), folding processing such as quadruple folding is performed in the folding function section 50 by the adjustment of the positions of the first and second end guides 62 and 64.

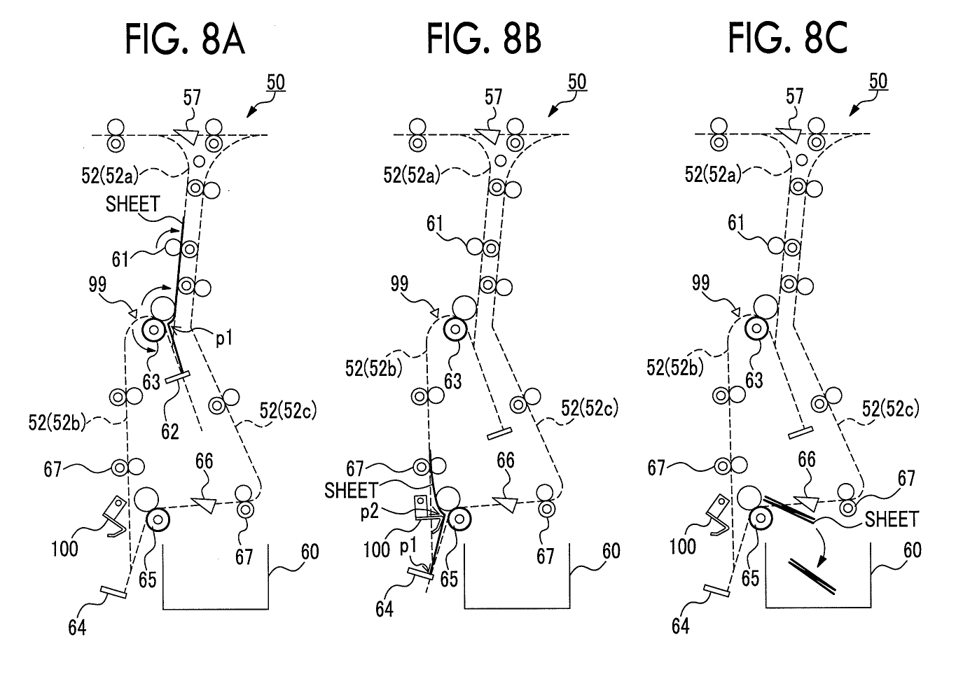

Furthermore, it is also possible to perform Z-folding other than Z-folding for an envelope by adjusting the positions of the first and second end guides 62 and 64. Specifically, Z-folding where folding processing is performed in the middle portion of a large-side sheet such as an A3 sheet and folding processing is performed in the middle portion of one of two pieces formed by this folding processing can be performed as shown in FIG. 9 (a view showing an example of the sheet on which Z-folding has been performed).

Meanwhile, when the Z-folding shown in FIG. 9 is performed by the folding function section 50, folding processing is performed at a portion (a portion denoted by reference numeral 9A of FIG. 9) that corresponds to ¼ of the length of the sheet from the front end of the sheet at the time of the first folding processing performed by the first folding roll 63 and folding processing is performed in the middle portion of the sheet (a portion denoted by reference numeral 9B of FIG. 9) at the time of the second folding processing performed by the second folding rolls 65.

Incidentally, since folding processing, which is performed two times as described above, is used as a basic operation in the folding function section 50 of this exemplary embodiment, folding processing is performed two times on the sheet that is transported to the folding function section 50. Meanwhile, if the folding processing is performed one time so that a double-folded sheet can be formed, patterns of folding processing are increased. Accordingly, convenience for a user is further improved. Here, since the folding function section 50 of this exemplary embodiment is adapted so as to also be capable of performing double folding, it is possible to perform double folding without separately preparing a device that performs double folding.

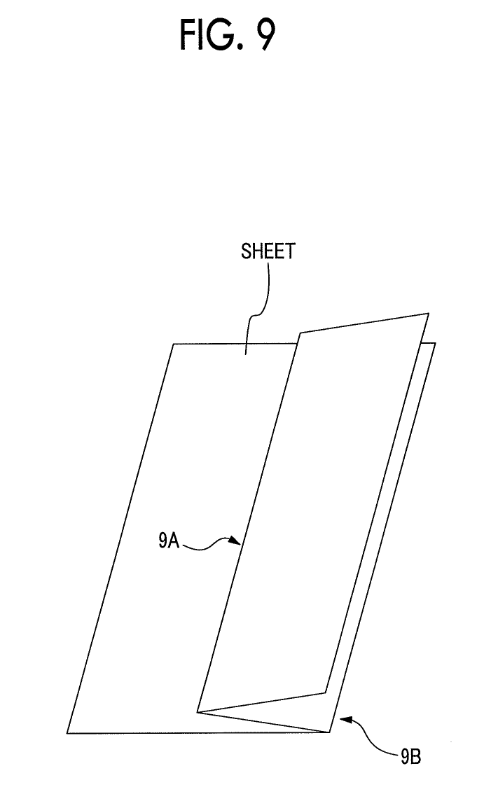

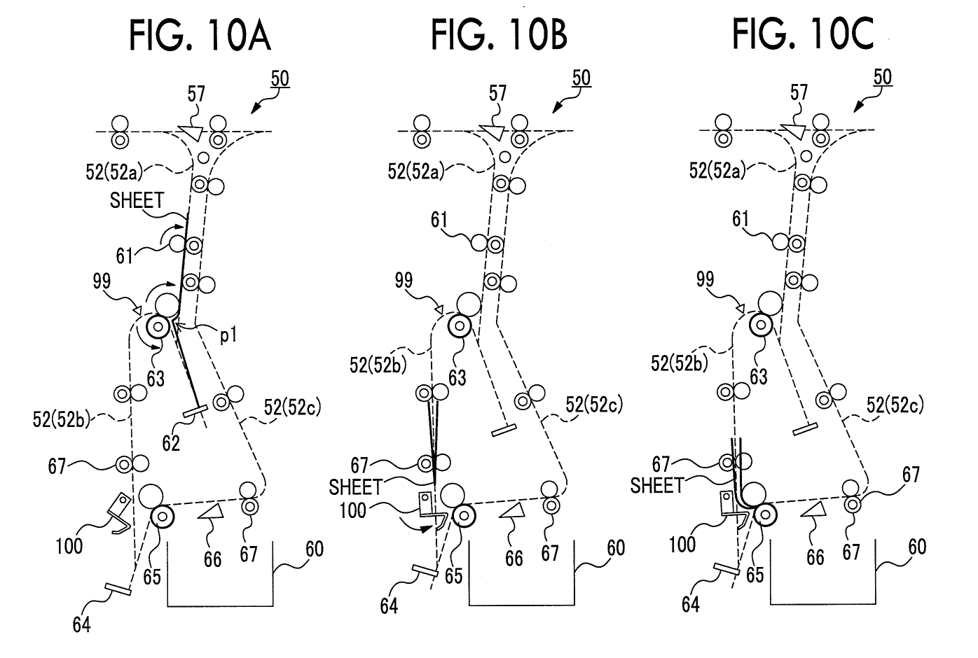

FIGS. 10A, 10B, 10C, 11A, and 11B are views illustrating the operation of the folding function section 50 when double folding is performed.

When double folding is performed in the folding function section 50, the position of the first end guide 62 is adjusted so as to correspond to ½ of the size of a sheet to be folded as shown in FIG. 10A. In detail, the position of the first end guide 62 is adjusted so that the middle portion of the sheet in the sheet transport direction is positioned at a position facing the first folding roll 63 when the front end of the sheet bumps against the first end guide 62. Further, when double folding is performed, the switching gate 66 recedes from the return bypass transport path 52c and is set to prevent the sheet from being moved to the sheet accommodating device 60.

When such a setting is made, the sheet from the image forming apparatus 1 is sent to the inlet bypass transport path 52a. Furthermore, even in this case, the sheet is transported via the skew correction roll 61 as described above and is further transported until the front end of the sheet bumps against the first end guide 62. Moreover, as described above, the sheet is further transported at a speed, which is equal to or lower than the speed of the first folding roll 63, while the front end of the sheet bumps against the first end guide 62.

Accordingly, the middle portion of the sheet (the middle portion of the sheet in the sheet transport direction) is buckled and a loop is formed in the space in front of the first folding roll 63. In detail, the sheet is buckled and a loop is formed at a portion that is distant from the front end of the sheet by ½ of the length of the sheet. Further, as described above, the sheet is sent to the first folding roll 63 so that a buckled portion (a loop portion) becomes the head, and the first folding processing is performed as shown in FIG. 10B.

After that, the sheet is moved along the intermediate bypass transport path 52b toward the sheet guide section 100 as shown in FIG. 10B. However, in this processing, the solenoid 103 is turned on until the front end of the sheet reaches the sheet guide section 100. Accordingly, the sheet guide section 100 protrudes onto the intermediate bypass transport path 52b as shown in FIG. 10B. In detail, the end portions 101a (see FIG. 4) of the sheet guide 101 protrude onto the intermediate bypass transport path 52b.

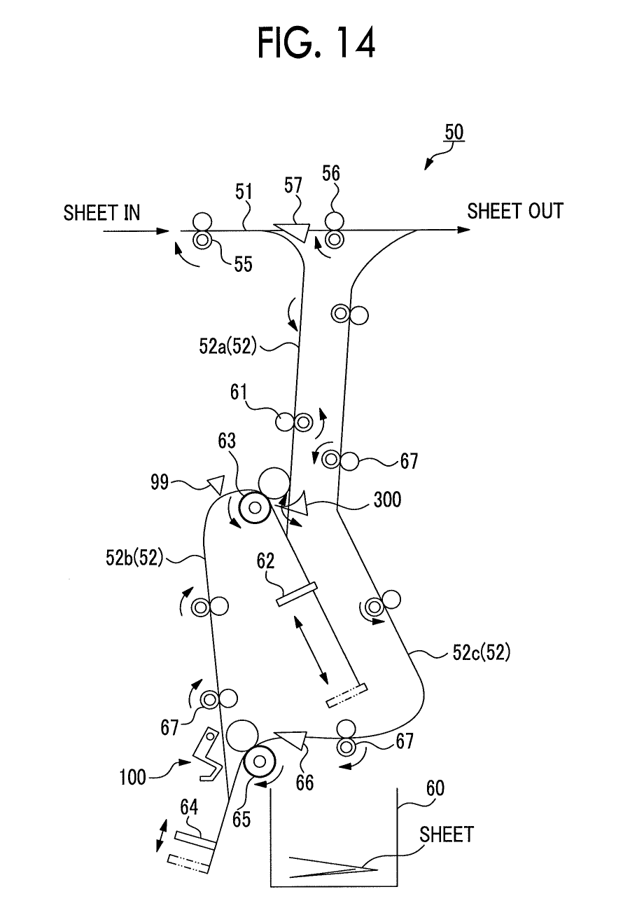

Accordingly, in this processing, the front end of the sheet bumps against the edge portions 106A (see FIG. 4) of the sheet guide 101, so that the sheet is moved toward the second folding rolls 65 as shown in FIG. 100. In detail, in this exemplary embodiment, the sheet guide 101 is used to guide a sheet and the sheet is sent to the second folding rolls 65 due to this guide.

In more detail, in this processing, the sheet is sent to the second folding rolls 65 by the sheet guide section 100 and the transport roll 67 functioning as a second sending member so that the downstream end portion of the sheet, which is positioned on the downstream side in the sheet transport direction, becomes the head. In more detail, the sheet is sent to the second folding rolls 65 so that a portion of the sheet on which folding processing has been performed by the first folding roll 63 becomes the head (so that an end portion of the sheet opposite to a spread portion of the sheet becomes the head). After that, in this exemplary embodiment, the sheet starts to be nipped by the second folding rolls 65 and starts to be transported by the second folding rolls 65 as shown in FIG. 11A.

Meanwhile, in this processing, the solenoid 103 (see FIG. 3) is turned off and the sheet guide section 100 (the end portions 101a of the sheet guide 101) recedes from the intermediate bypass transport path 52b as shown by an arrow of FIG. 11A when the sheet starts to be nipped by the second folding rolls 65. Here, when the sheet guide section 100 protrudes onto the intermediate bypass transport path 52b as it is, a sheet transport path is bent (the curvature of the sheet transport path is increased). In this case, there is a concern that the transport of a sheet may be hindered if the sheet is a cardboard or the like.

For this reason, when the sheet starts to be nipped by the second folding rolls 65 and the sheet starts to be transported by the second folding rolls 65, the sheet guide section 100 recedes from the intermediate bypass transport path 52b in this exemplary embodiment so that the curvature of the sheet transport path is reduced. In detail, until the rear end of the sheet passes through the sheet guide section 100 after the sheet starts to be transported by the second folding rolls 65, the sheet guide section 100 recedes from the intermediate bypass transport path 52b in this exemplary embodiment so that the curvature of the sheet transport path is reduced.

After that, as shown in FIG. 11B, the sheet is further transported via the return bypass transport path 52c and transported to the finisher 5 (see FIG. 1). Meanwhile, the sheet, which is transported to the finisher 5, is discharged to the outside of the apparatus after being transported via, for example, the punch function section 70. At this time, punching processing may be performed on the sheet by the punch function section 70 and the sheet may be discharged as it is without punching processing.

Further, in the folding function section 50 of this exemplary embodiment, the sheet on which folding processing (double folding) has been performed one time is adapted so as to be capable of being discharged to the outside after being subjected to switchback (the switch between the front and rear end portions of the sheet).

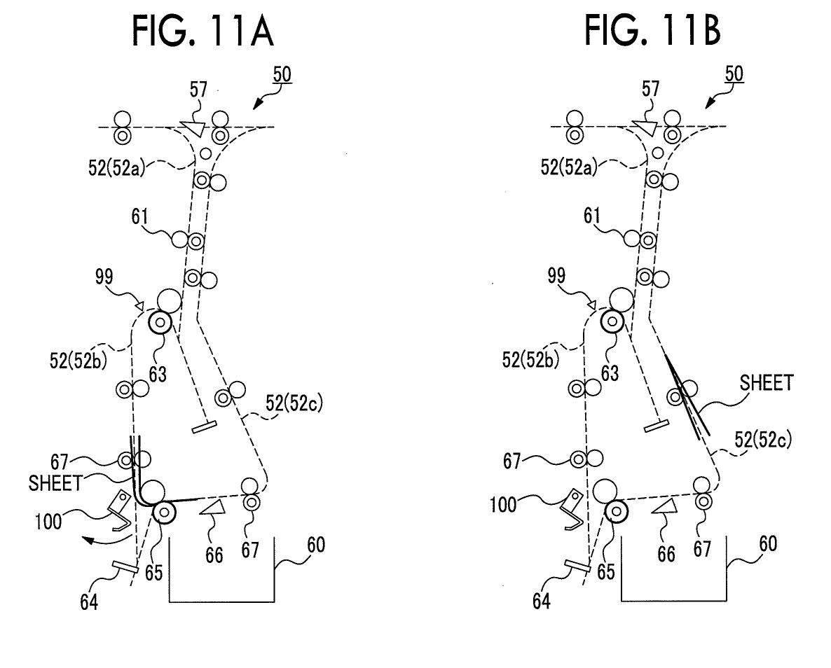

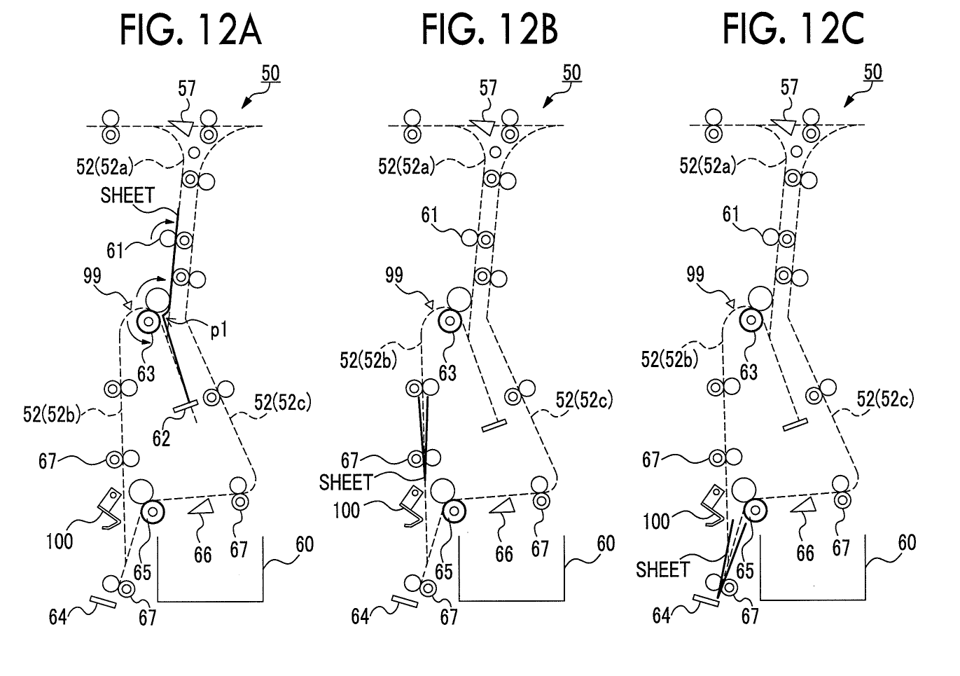

FIGS. 12A, 12B, 12C, 13A, and 13B are views illustrating the operation of the folding function section 50 when the switchback of a sheet is performed.

Even in this processing, first, the position of the first end guide 62 is adjusted so as to correspond to ½ of the size of a sheet to be folded as shown in FIG. 12A. Further, even in this processing, the switching gate 66 recedes from the return bypass transport path 52c and is set to prevent the sheet from being moved to the sheet accommodating device 60.

When such a setting is made, the sheet from the image forming apparatus 1 is sent to the inlet bypass transport path 52a as described above. Furthermore, even in this case, the sheet is transported via the skew correction roll 61 and is further transported until the front end of the sheet bumps against the first end guide 62. After that, as described above, the sheet is transported at a speed, which is equal to or lower than the speed of the first folding roll 63, while the front end of the sheet bumps against the first end guide 62.

Accordingly, the middle portion of the sheet is buckled and a loop is formed in the space in front of the first folding roll 63. Moreover, the sheet is caught in the first folding roll 63 from the middle portion thereof, so that the first folding processing is performed as shown in FIG. 12B. After that, the sheet is moved along the intermediate bypass transport path 52b toward the sheet guide section 100. However, in this processing, as shown in FIG. 12B, the solenoid 103 is maintained as it is while being turned off and the sheet guide section 100 recedes from the intermediate bypass transport path 52b.

Accordingly, the sheet is further sent along the inlet bypass transport path 52a, so that the upstream end portion (rear end) of the sheet has passed through the sheet guide section 100 as shown in FIG. 12C. Then, in this processing, the solenoid 103 is turned on and the sheet guide section 100 (the end portions 101a of the sheet guide 101) protrudes onto the intermediate bypass transport path 52b as shown in FIG. 13A. After that, the transport roll 67, which is nipping the sheet, is rotated in a reverse direction. Accordingly, the sheet is moved toward the sheet guide section 100 so that the upstream end portion of the sheet becomes the head.

Further, when the sheet reaches the sheet guide section 100, the front end (upstream end portion) of the sheet comes into contact with the downstream side surfaces 112 (see FIGS. 3 and 4) formed on the sheet guide 101 and the sheet is guided to the second folding rolls 65 by the downstream side surfaces 112. After that, the sheet starts to be nipped by the second folding rolls 65 and starts to be transported by the second folding rolls 65. Meanwhile, even in this processing, the solenoid 103 is turned off and the sheet guide section 100 recedes from the intermediate bypass transport path 52b as shown in FIG. 13B when the sheet starts to be nipped by the second folding rolls 65.

After that, as described above, the sheet is further transported via the return bypass transport path 52c and is transported to the finisher 5 (see FIG. 1) as shown in FIG. 13B. Furthermore, this sheet is discharged to the outside of the apparatus after being transported via, for example, the punch function section 70.

Here, the finisher 5 is provided with various function sections. However, since the various function sections are generally fixed, it is difficult to flexibly change the position of a portion, which is to be subjected to processing, on the sheet. If a structure where switchback can be performed is employed as in this processing, it is possible to change the position of a portion, which is to be subjected to processing, on the sheet while the function sections are fixed. For example, binding can be performed on only a portion, which is positioned on the downstream side, of the sheet, but it is also possible to perform binding on a portion, which is positioned on the upstream side, of the sheet.

Meanwhile, the sheet has been guided to the second folding rolls 65 by using the sheet guide section 100 in the processing shown in FIGS. 10A, 10B, 10C, 11A, and 11B (processing when double folding is performed) and the processing shown in FIGS. 12A, 12B, 12C, 13A, and 13B (processing for performing double folding and switchback). However, a dedicated part for guiding a sheet may be provided separately from the sheet guide section 100 and the sheet may be guided to the second folding rolls 65 by the dedicated part. Meanwhile, when the sheet guide section 100 is used, the number of parts is reduced. Further, the size of the apparatus is apt to be reduced.

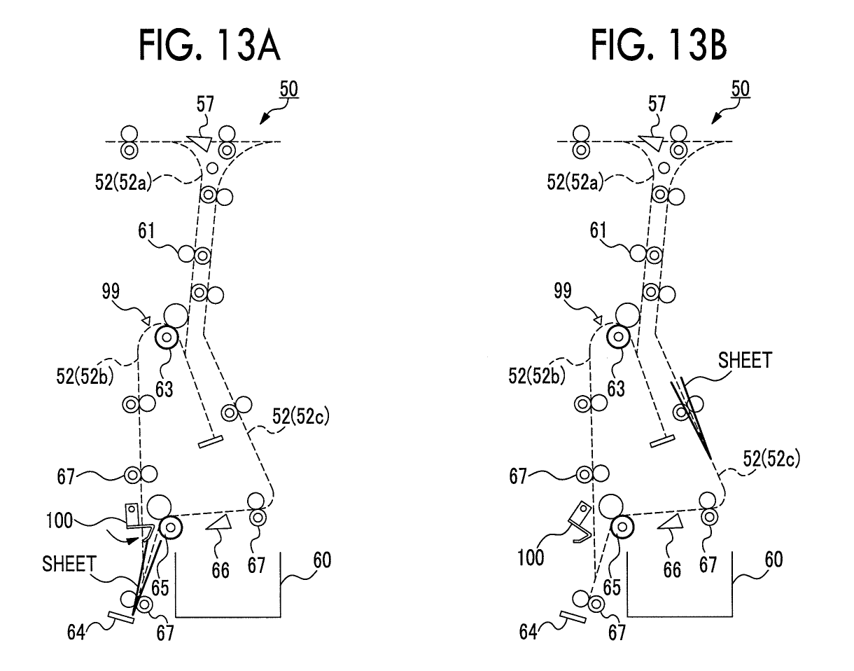

Furthermore, a case where the first folding processing is performed by the first folding roll 63 and the sheet is made to pass as it is without folding processing at the second folding rolls 65 when the double folding is performed has been described above. However, for example, a structure shown in FIG. 14 (a view showing another example of the structure of the folding function section 50) may be used so that a sheet passes through the first folding roll 63 and is subjected to first folding processing by the second folding rolls 65.

In the example of the structure shown in FIG. 14, a switching gate 300, which advances and recedes relative to the inlet bypass transport path 52a, is provided on the inlet bypass transport path 52a near the first folding roll 63. Moreover, when double folding is performed in this example of the structure, a sheet is made to pass as it is by the switching gate 300 without folding processing at the first folding roll 63. Further, folding processing is performed on a sheet at the second folding rolls 65. Meanwhile, in the case of the example of the structure shown in FIG. 14, a sheet is made to pass through the first folding roll 63 and can be subjected to folding processing at the second folding rolls 65. However, processing is not limited to this processing, and folding processing may be performed at the first folding roll 63 and the sheet may be made to pass through the second folding rolls 65.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A sheet processing apparatus comprising:
a sheet transport path along which a sheet is transported; and
a plurality of folding members that are disposed at positions different from each other on the sheet transport path in a sheet transport direction and perform folding processing on the sheet transported along the sheet transport path,
wherein any folding member of the plurality of folding members includes
a transport unit that includes a first transport member and a second transport member disposed so as to come into contact with the first transport member and transports a sheet, which is sent to a contact portion where the first and second transport members come into contact with each other, to the downstream side,
a first sending member that is positioned on the upstream side of the transport unit in the sheet transport direction, and sends the sheet to the contact portion so that a portion of the transported sheet, which is positioned closer to an upstream end portion than an downstream end portion of the transported sheet positioned on the downstream side in the sheet transport direction and is positioned closer to the downstream end portion than the upstream end portion, becomes a head, and
a second sending member that is positioned on the upstream side of the transport unit in the sheet transport direction, and sends the sheet to the contact portion so that any of the upstream end portion and the downstream end portion of the transported sheet becomes a head.

2. The sheet processing apparatus according to claim 1, further comprising:
an advance member that advances toward the contact portion from the side opposite to the side where the contact portion nipping the sheet is provided when the sheet is sent to the contact portion by the first sending member,
wherein the second sending member sends the sheet to the contact portion by the advance member.

3. The sheet processing apparatus according to claim 2,
wherein the second sending member makes the advance member advance toward the contact portion, sends the sheet to the contact portion by the advance member that has advanced, and moves the advance member in a direction where the advance member is separated from the contact portion after the sent sheet reaches the contact portion and starts to be transported by the transport unit.

4. The sheet processing apparatus according to claim 1,
wherein when sending the sheet to the contact portion, the second sending member of the folding member, which includes the transport unit, the first sending member, and the second sending member, sends the sheet to the contact portion so that a portion on which folding processing has been performed by the other folding members positioned on the upstream side of the folding member in the sheet transport direction becomes a head.

5. The sheet processing apparatus according to claim 2,
wherein when sending the sheet to the contact portion, the second sending member of the folding member, which includes the transport unit, the first sending member, and the second sending member, sends the sheet to the contact portion so that a portion on which folding processing has been performed by the other folding members positioned on the upstream side of the folding member in the sheet transport direction becomes a head.

6. The sheet processing apparatus according to claim 3,
wherein when sending the sheet to the contact portion, the second sending member of the folding member, which includes the transport unit, the first sending member, and the second sending member, sends the sheet to the contact portion so that a portion on which folding processing has been performed by the other folding members positioned on the upstream side of the folding member in the sheet transport direction becomes a head.

7. An image forming system comprising:
an image forming section that forms an image on a sheet;
a sheet transport path along which the sheet on which the image has been formed by the image forming section is transported; and
a plurality of folding members that are disposed at positions different from each other on the sheet transport path in a sheet transport direction and perform folding processing on the sheet transported along the sheet transport path,
wherein any folding member of the plurality of folding members includes
a transport unit that includes a first transport member and a second transport member disposed so as to come into contact with the first transport member and transports a sheet, which is sent to a contact portion where the first and second transport members come into contact with each other, to the downstream side,
a first sending member that is positioned on the upstream side of the transport unit in the sheet transport direction, and sends the sheet to the contact portion so that a portion of the transported sheet, which is positioned closer to an upstream end portion than an downstream end portion of the transported sheet positioned on the downstream side in the sheet transport direction and is positioned closer to the downstream end portion than the upstream end portion, becomes a head, and
a second sending member that is positioned on the upstream side of the transport unit in the sheet transport direction, and sends the sheet to the contact portion so that any of the upstream end portion and the downstream end portion of the transported sheet becomes a head.
